(19) United States
(12) Patent Application Publication
(10) Pub. No.: US 2022/0340406 A1
(43) Pub. Date: Oct. 27, 2022

(54) THERMOELECTRIC COOLING AND COMPACT CARBONATION SYSTEM

(71) Applicant: Elkay Manufacturing Company, Downers, IL (US)

(72) Inventor: Erik Lynch, Downers Grove, IL (US)

(21) Appl. No.: 17/239,390

(22) Filed: Apr. 23, 2021

(51) Int. Cl. B67D 1/08; B67D 1/00

(52) U.S. Cl. CPC B67D 1/0869; B67D 1/0062; B67D 1/007; B67D 1/0058; B67D 2001/0093

(57) ABSTRACT

An example beverage dispensing system includes a liquid circulation loop including a reservoir. The system also includes an inlet coupled to the liquid circulation loop to enable liquid to enter the liquid circulation loop, a thermoelectric cooling assembly configured to lower a temperature of liquid in the liquid circulation loop, a carbonation assembly configured to add carbonation to the liquid in the liquid circulation loop, a pump configured to circulate liquid through the liquid circulation loop, and an outlet coupled to the liquid circulation loop to enable liquid to exit the liquid circulation loop.

### TECHNICAL FIELD

The present disclosure relates generally to systems and devices for dispensing liquids (e.g., water), in particular a compact system for dispensing both chilled carbonated water and chilled uncarbonated water, without the use of a compressor or independent refrigeration loop.

### BACKGROUND

From a consumer's perspective, it is advantageous for a beverage dispensing system to be able to provide chilled water on demand, with the option for both chilled carbonated water, and chilled uncarbonated water. Some beverage dispensers accomplish this goal by including large cooling systems that involve refrigerants or other chemicals which may be disfavored by consumers and manufacturers alike. Some beverage dispensers also or alternatively use ice banks. However, ice banks may be bulky, and may have less than ideal operational characteristics for certain use cases. Some beverage dispensers also provide carbonation through the use of a compressor to increase the amount of carbonation. Compressors are loud, and thus provide a less than ideal experience for some use cases, particularly when used in a home or office environment.

### SUMMARY

The present disclosure summarizes aspects of some contemplated embodiments, and should not be used to limit the scope of the claims. Other implementations are contemplated in accordance with the techniques described herein, as will be apparent to one having ordinary skill in the art upon examination of the following drawings and detailed description, and these implementations are intended to be within the scope of this application.

In a first example, a beverage dispensing system includes a liquid circulation loop, the liquid circulation loop including a reservoir. The beverage dispensing system also includes an inlet coupled to the liquid circulation loop to enable liquid to enter the liquid circulation loop; a thermoelectric cooling assembly configured to lower a temperature of liquid in the liquid circulation loop; a carbonation assembly configured to add carbonation to the liquid in the liquid circulation loop; a pump configured to circulate liquid through the liquid circulation loop; and an outlet coupled to the liquid circulation loop to enable liquid to exit the liquid circulation loop.

In a second example, a beverage dispensing system includes an inlet; a first liquid circulation loop including a first reservoir; a first pump configured to circulate liquid through the first liquid circulation loop; a second liquid circulation loop including a second reservoir; a carbonation assembly configured to add carbonation to the liquid in the second liquid circulation loop; a second pump configured to circulate liquid through the second liquid circulation loop; a thermoelectric cooler configured to lower a temperature of liquid circulating in both the first liquid circulation loop and the second liquid circulation loop; and an outlet coupled to the first liquid circulation loop and the second liquid circulation loop.

In a third example, a compact carbonation system for a beverage dispenser includes a tube and a compact carbonation device positioned inside the tube. The compact carbonation device includes a central member extending along a longitudinal axis, and a plurality of pairs of paddles attached to the central member and positioned adjacent to each other along the longitudinal axis. A first pair of the plurality of pairs of paddles extends in a first helical direction with respect to the longitudinal axis, and a second pair of the plurality of pairs of paddles adjacent to the first pair extends in an opposing helical direction, such that a rotational component of the second pair is opposite to a rotational component of the first pair.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example simplified block diagram of a beverage dispensing system of the present disclosure, including a single liquid circulation loop.

FIG. 2 illustrates an example simplified block diagram of a second beverage dispensing system of the present disclosure, including both a first and a second liquid circulation loop.

FIGS. 3A, 3B, and 3C illustrate three different views of an example compact carbonation device of the present disclosure.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

As noted above, beverage dispensers may be configured to provide both chilled carbonated water and chilled uncarbonated water. This may be beneficial to consumers, who may wish to have both options available. Furthermore, consumers and manufacturers of beverage dispensing systems may desire a small form factor, low noise, fewer components, and less or no harmful refrigerant chemicals than are in existing available beverage dispensing systems.

In embodiments of the present disclosure, a beverage dispensing system may be connected to a water source that may supply relatively warm water. It may be desirable to chill the water to below a threshold temperature, such as below 39 degrees Fahrenheit. The example beverage dispensing system may make use of a thermoelectric cooler (TEC), combined with a reservoir of water surrounded by a phase change material (PCM). The PCM may have a relatively low melting point, such that it acts to extract heat from the water in the reservoir, and thereby enable chilled water to exit the beverage dispensing system. When the beverage dispensing system is at rest (i.e., no liquid is being dispensed), the liquid may be pumped around the liquid circulation loop of the system. The liquid circulation loop may include passing the liquid through the TEC and the PCM, thereby reducing the temperature of the water, and re-freezing the PCM if it has melted. When the beverage dispensing system dispenses liquid, relatively warm liquid from the source is input into the liquid circulation loop, while chilled liquid is dispensed. The relatively warm water is partially cooled by the TEC, and then is further cooled by PCM when it passes through the reservoir by melting the PCM. The PCM acts as a “cold battery” to draw out heat from the liquid when the system dispenses liquid. This enables the system as a whole to have a greater on-demand throughput, without the need to reset or recover. Additionally, the example beverage dispensing system includes a carbonation assembly placed in-line, such that the output water can be either carbonated or uncarbonated on-demand.

In one example using numbers, the incoming water may be around 77 degrees Fahrenheit. IT may be desired for the output water to be chilled to 39 degrees Fahrenheit. The TEC may not be able to fully chill water from 77 degrees to 39 degree in one pass. Rather, the TEC may be only able to chill the water by 15 degrees. Over time, the TEC may reduce the temperature of all the water in the liquid circulation loop to at or below 39 degrees. However, depending on the amount of water in the liquid circulation loop, the beverage dispensing system may only be able to dispense a limited number of ounces before the TEC cannot keep up, and the temperature of the output liquid increases to above a desirable threshold (e.g., 39 degrees).

The PCM can augment the TEC cooling, and cool the water down as it passes through the reservoir. The PCM may have a melting point of, for example, 36 degrees Fahrenheit, and may melt as the warmer water passes through, thereby cooling down the water to below 39 degrees. This enables the beverage dispensing system to chill the water from 77 degrees to 39 degrees in one pass, thereby increasing the number of ounces that can be output below the desired temperature threshold of 39 degrees before the system stops to recover and re-freeze the PCM.

In many use cases such as home or office use, this combination of cooling from the TEC and the PCM is sufficient to provide on-demand chilled water for all who want it. For example, in an office setting, the system may be designed to operate without needing to recover for a sufficient number of output ounces, which may correspond to the typical amount used during a day of work. Then when the office is empty at night and the beverage dispensing system is not in use, the system may have sufficient time to re-freeze the PCM without needing to provide any output water. The system may then be prepared for use the next morning. Additionally, during the day when the beverage dispenser is not actively in use (i.e., not dispensing liquid), the system may pump the liquid through the liquid circulation loop to us the TEC to cool the liquid down. In this way, whenever the beverage dispensing system is not actively dispensing liquid, the system is cooling the liquid down and attempting to re-freeze any PCM that has melted.

Other beverage dispensing systems may use an ice bank, refrigerant lines, or other noisy components and/or harmful substances. Other systems may also use compressors for the carbonation process. Each of these components has drawbacks, which may be, in part, alleviated by the example systems disclosed herein. For example, the use of the TEC in combination with the PCM enables a relatively long duration of available chilled liquid, without needing to stop and recover. In addition, the example system does not include a separate refrigeration line or cooling loop to remove heat from the system. The lack of refrigerant means that the example system does not produce greenhouse gasses, and can meet strict environmental standards. The example system also does not use a compressor to add carbonation, thereby avoiding the noise created by the compressor. The compact form of the example system allows for in home and office use with an output that is comparable to larger and more complicated devices.

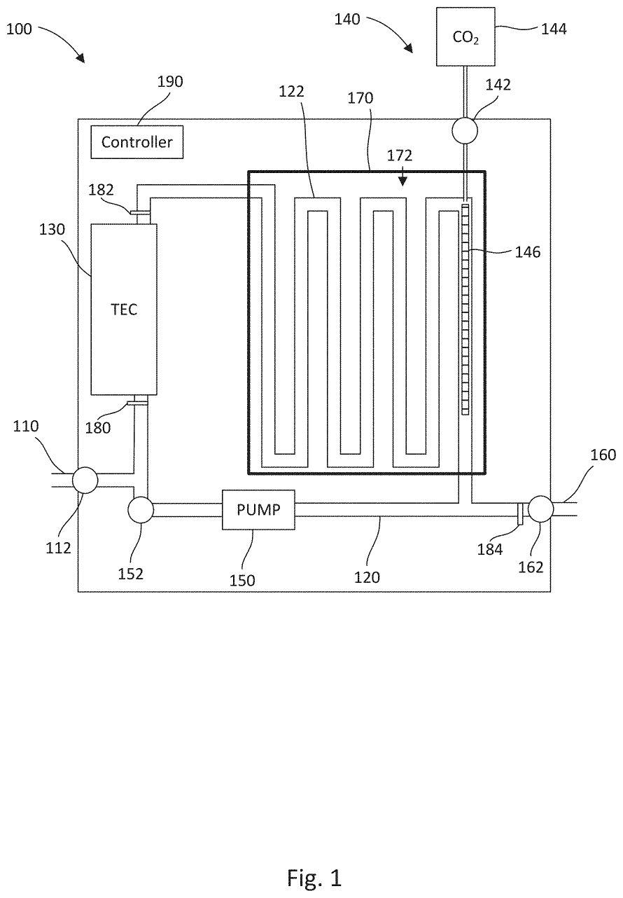

FIG. 1 illustrates a simplified block diagram of an example beverage dispensing system 100 having a single liquid circulation loop, according to embodiments of the present disclosure. The beverage dispensing system 100 includes an inlet 110, a liquid circulation loop 120, a thermoelectric cooler 130, a carbonation assembly 140, a pump 150, an outlet 160, a phase change assembly 170, one or more temperature sensors 180, 182, and 184, and a controller 190. Various other components may also be included.

The inlet 110 enables liquid, such as water, to enter the liquid circulation loop 120. The inlet 110 may be connected to a water source, such as a tap or other municipal source. The liquid from the liquid source that is connected to the inlet 110 may be at a relatively high temperature, compared to a desired output temperature of the beverage dispensing system 100. As such, it may be desirable for the beverage dispensing system 100 to chill the liquid down to below a threshold temperature. The liquid source may have a nominal positive pressure, such that simply opening the inlet valve 112 enables liquid to enter the liquid circulation loop 120. No additional pump may be required to provide liquid into the liquid circulation loop 120 from the inlet 110.

The inlet pressure provided by the liquid source may also be used to push chilled liquid out of the outlet 160. This may be done by opening both the inlet valve 112 of the inlet 110 at the same time as the outlet valve 162 of the outlet 160. In some examples, the controller may be configured to control the inlet valve 112 and the outlet valve 162 such that they are either both open or both closed (i.e., that they change state from open to closed or closed to open simultaneously or at the same/similar time). In some examples, the inlet valve 112 may be a one-way valve configured to enable liquid to enter the liquid circulation loop, but prevent liquid from exiting the liquid circulation loop.

The liquid circulation loop 120 may enable liquid in the beverage dispensing system 100 to pass through the various components of the beverage dispensing system 100 multiple times (e.g., passing through the TEC multiple times). The liquid circulation loop 120 may form a closed loop when both the inlet valve 112 and the outlet valve 162 are closed. The liquid circulation loop 120 may comprise tubing or piping of various lengths, widths, diameters, shapes, materials, etc. In some examples, the liquid circulation loop may include one or more of the other components of the beverage dispensing system 100. In some examples, the liquid circulation loop 120 includes a one-way valve 152, configured such that liquid within the loop 120 flows only in one direction.

The thermoelectric cooler (TEC) 130 may be configured to reduce a temperature of liquid that passes through. This may be done by using an applied voltage to the TEC to extract heat from the liquid. The voltage applied, and thus the amount of heat extracted, may be variable, and may be controlled by one or more other components of the beverage dispenser. For instance, the controller 190 may be configured to reduce or increase the amount of heat extracted from the liquid based on signals received from one or more of the temperature sensors 180, 182, and 184. In some examples, the amount of heat extracted by the TEC may be dependent upon the temperature of the liquid input to the TEC 130, the temperature of the liquid currently in the TEC 130, and/or the temperature of the liquid at the exit of the TEC 130. Because the liquid circulation loop 120 includes an inlet 110 that lets liquid into the loop 120 that may be a different temperature than the liquid currently in the loop 120, there may not be a uniform temperature throughout the liquid in the loop 120. If a high temperature is detected for incoming water to the TEC 130, the TEC 130 may ordinarily be configured to reduce the temperature as much as possible (i.e., the TEC may be turned on to full power). However, if the liquid currently in the TEC 130 is nearly frozen, or has a substantially different temperature than the liquid just received at the inlet 110, the TEC 130 may inadvertently cause the nearly frozen liquid in the TEC to freeze, based on the mistaken assumption that the liquid is at the higher inlet temperature. This may cause one or more components of the TEC 130 and/or liquid circulation loop 120 to break down. To avoid these issues, various temperature readings may be taken, and algorithms may be employed to avoid causing the liquid in the TEC to completely freeze. For instance, the pump 150 may be activated to attempt to homogenize the temperature of the liquid in the liquid circulation loop as quickly as possible after new liquid is input via the inlet 110, in order to reach a steady state temperature before the TEC 130 is fully turned on. Alternatively or in addition, the TEC may be activated at less than full power in some circumstances.

In some examples, such as the example shown in FIG. 1, the TEC 130 may be positioned along the liquid circulation loop 130 such that liquid enters the TEC 130 right after it is received at the inlet 110, and/or after it passes through the pump 150 and/or the one-way valve 152. The TEC 130 may be the first component of the beverage dispenser 130 that the water enters after being received in the inlet 110.

The TEC 130 may be any suitable size or shape, and may have any suitable power or energy consumption. As noted above, the TEC 130 may be configured to provide a modest amount of temperature reduction to the liquid in the liquid circulation loop 120 during a single “pass” through the TEC. When the inlet valve 112 and outlet valve 162 are both closed, the liquid in the loop 120 may be circulated through the loop 120 multiple times such that multiple “passes” through the TEC 130 occur, reducing the temperature of the liquid during each successive pass. When the liquid in the loop 120 reaches a steady state temperature that is below a desired threshold temperature, the TEC 130 may shut off, and/or may be intermittently turned on to maintain the liquid temperature below the desired threshold. As illustrated in FIG. 1, the use of the TEC 130 does not require a separate refrigerant loop, and thus does not cause harmful chemicals or greenhouse gasses to be generated.

The reservoir 122 may be a part of the liquid circulation loop 120, and may be position within the loop after the TEC 130. In the example shown in FIG. 1, the reservoir 122 comprises a series of tubing. It should be appreciated that other shapes, sizes, and configurations may be used as well. The reservoir 122 may be configured to hold a desired amount of liquid (e.g., 40 ounces), which may be determined based on the use case of the beverage dispenser. For example, a beverage dispenser for in-home use may have a smaller reservoir (e.g., 18 ounces), while a beverage dispenser for office use may have the larger, 40 ounce reservoir. It should be understood that these values are for illustration only, and that any suitable reservoir size may be used.

In some examples, the reservoir 122 may be surrounded in whole or in part by a phase change material assembly (PCM assembly) 170. The PCM assembly 170 may include a phase change material (PCM) 172, which may be configured to interact with the liquid in the reservoir 122 by melting due to a temperature difference with the liquid in some circumstances, and freezing due to the temperature difference with the liquid in other circumstances. The PCM assembly may include piping or tubing that forms a part of the liquid circulation loop 120, and/or forms a part of the reservoir 122. In some examples, the reservoir 122 may include a tube that is arranged such that a surface area that is in contact with the PCM 172 is maximized. In some examples, the reservoir 122 may be immersed in the PCM 172. The PCM assembly 170 may be an enclosed assembly, such that the PCM 172 does not leak out of the assembly 170. The assembly may include an inlet and an outlet, through which liquid enters and exits the PCM assembly 170.

In some examples, the PCM assembly may include one or more temperature sensors (not shown) that are configured to measure the temperature of the PCM 172. This information may be used by the controller 190.

In some examples, the PCM assembly 170 may be a modular assembly. Multiple PCM assemblies may be connected together in series or in parallel, to increase the size of the reservoir 122 that is in contact with the PCM 172. For instance, the PCM assembly 170 may comprise an eight inch by eight inch by one inch box, through when the reservoir 122 (e.g., tubing) passes. The PCM assembly box may be filled with the PCM 172, which makes contact with the reservoir 122. Multiple boxes may be connected together to increase the capacity of the reservoir 122.

In some examples, the PCM 172 may be a soy-based wax. The PCM may be selected or designed such that it has a particular melting point based on the melting point of the liquid in the reservoir 122. The desired PCM melting point may also be selected or designed such that it is near the desired temperature for the output of the beverage dispensing system 100. In some examples, there may be a relationship between (1) the freezing/melting temperature of the liquid in the liquid circulation loop 120, (2) the freezing/melting temperature of the PCM 172, and (3) the desired output temperature of the beverage dispensing system 100. For instance, (1) the liquid freezing/melting temperature may be 32 degrees Fahrenheit, (2) the PCM freezing/melting temperature may be 39 degrees Fahrenheit, and (3) the desired output temperature may be 39 degrees Fahrenheit or less.

This relationship may enable the PCM 172 to melt, thereby drawing out heat from the liquid, and to freeze at a later time when the system is not being used. In particular, the PCM 172 may have a freezing temperature that is greater than a freezing temperature of the liquid in the liquid circulation loop 120, wherein the PCM is configured to (1) absorb heat from liquid in the reservoir 122 when a temperature of the liquid in the reservoir 122 is greater than a temperature of the PCM 172, and (2) release heat into the liquid in the reservoir 122 when the temperature of the liquid in the reservoir 122 is less than the temperature of the PCM 172.

The carbonation assembly 140 may include a carbonation valve 142, and a carbonation source 144. In some cases, adding carbonation to a liquid is more effective and efficient when the temperature of the liquid is lower (e.g., it is easier to add carbonation to 35 degree water as opposed to 55 degree water). Due in part to this relationship, the carbonation assembly 140 may be positioned along the liquid circulation loop 120 such that it injects carbonation into the liquid either (1) at the end of the reservoir 122, within the PCM assembly 170, as shown in FIG. 4, or (2) after the reservoir 122 and PCM assembly 170. This point along the liquid circulation loop may have the most consistently chilled liquid, and thus enables the greatest carbonation performance for the beverage dispensing system 100.

The carbonation valve 142 may be controlled by the controller 190, in order to enable carbonation to be added in-line with the liquid circulation loop 120. This means that the beverage dispenser does not need a separate carbonation loop from the main water circulation loop, thereby reducing complexity and failure points. The in-line carbonation also enables on-demand carbonation, such that a first drink dispensed is carbonated, while a next drink is not carbonated.

Carbonation is added to the liquid in-line with the liquid circulation loop-120 by passing the liquid and CO₂ through a compact carbonation device 146.

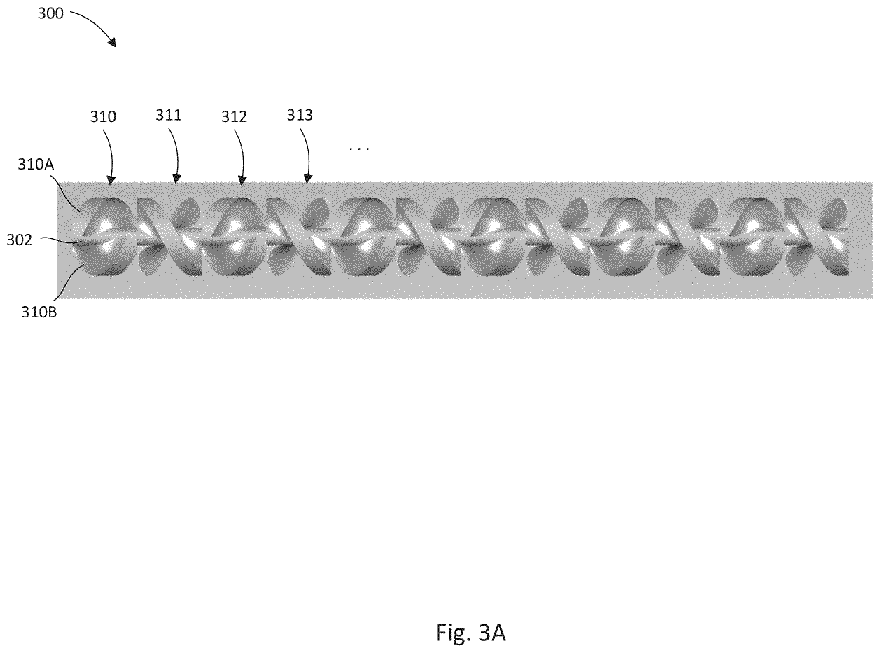

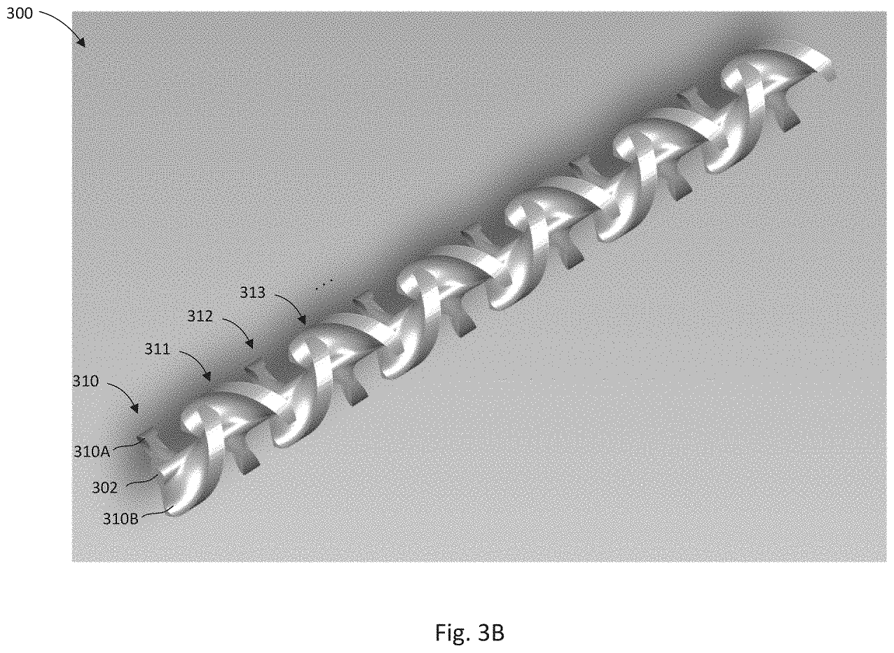

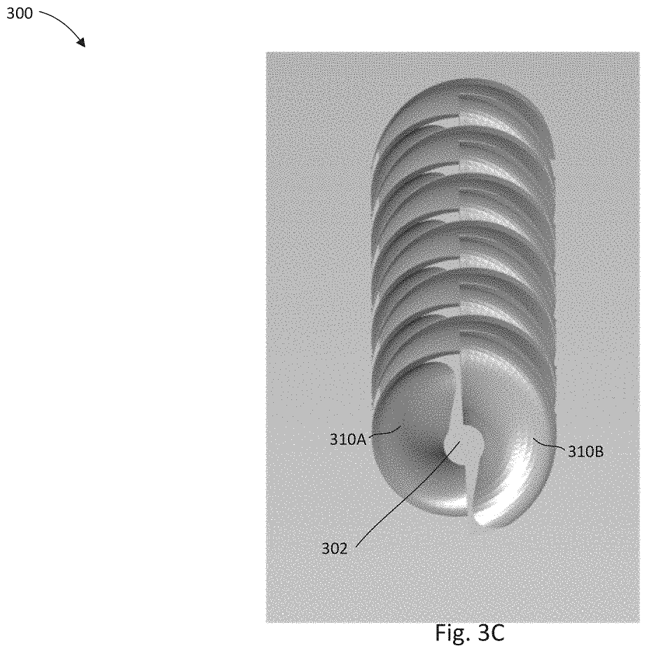

FIGS. 3A, 3B, and 3C illustrate views of an example compact carbonation device 300. The device 300 may be the same as device 146 (and/or 246 discussed below).

The device 300 may be part of a compact carbonation system, which includes a tube and the compact carbonation device 300 positioned coaxially within the tube. The compact carbonation device 300 may include a central member 302, and a plurality of pairs of paddles (which may also be called baffles) 310, 311, 312, 313, etc.

The central member 302 extends along a longitudinal axis of the device 300, and may have a cylindrical cross section (e.g., as shown in FIG. 3C). It should be appreciated that other shapes may be used as well. The central member 302 may be solid as in FIGS. 3A, 3B, and 3C, or may be hollow in whole or in part.

The plurality of pairs of paddles 310, 311, 312, 313, etc. may be positioned adjacent to each other along the length of the central member, or along the longitudinal axis of the central member, as illustrated in FIG. 3A. The pairs of paddles may be positioned such that they abut each other (e.g., there is no or minimal gap between adjacent pairs, as shown in FIG. 3A), or may be positioned such that there is space or a gap between adjacent pairs.

Each paddle may include a particular pitch, such as between 40-50 degrees. However, it should be understood that other pitches may be used as well. Each paddle extends in a helical direction with respect to the longitudinal axis of the central member 302. That is, each paddle extends in a helical direction that includes a longitudinal component and a rotational component. For example, paddle 310A in FIG. 3A extends with a longitudinal component along the length of the central member 302, and a rotational component in a counterclockwise direction around the central member 302, when viewed head on (e.g., as shown in FIG. 3C). Similarly, paddle 310B has a longitudinal component along the length of the central member 302, and a rotational component in a counterclockwise direction around the central member 302.

Adjacent pairs of paddles have rotational components in opposite directions. For example, the first pair 310 of the plurality of pairs of paddles extends in a first helical direction (to the right) with respect to the longitudinal axis. The first pair of paddles 310 also have a rotational component in a counterclockwise direction. The second pair 311, adjacent to the first pair 310, extends in an opposing helical direction, such that the rotational component of the second pair 311 is clockwise (i.e., opposite) to the rotational component of the first pair 310. The pairs 310, 311, 312, 313, etc. may alternate between clockwise and counterclockwise rotational components.

FIGS. 3A, 3B, and 3C illustrate that each section of the central member 302 may include a pair of paddles, and each paddle of the pair may have a rotational component that extends 180 degrees. The combined pair may therefore cover 360 degrees when viewed head on as in FIG. 3C. However, it should be understood that each section of the central member 302 may instead include three or more paddles. Further, the combined paddles may have a combined rotational component of 360 degrees (e.g., for three paddles, each paddle may have a 120 degree rotational component; for four paddles, each may have a 90 degree rotational component, etc.). The combined rotational component of the paddles for a given section of the central member 302 may add up to 360 degrees, or may be more or less. Further, the rotational component of each paddle of a given section may be the same, or may be different.

In some examples, the length of the compact carbonation device 300 may be 5 inches, 10 inches, or any other suitable length. Longer length may provide improved carbonation, however when used in connection with rest of system described herein, longer length may result in undesirable residual carbonated liquid being dispensed. Therefore a tradeoff occurs between length and operational characteristics of the system.

In some examples, the inner diameter of the tube may be a half inch. The outer diameter of the compact carbonation device 300 (i.e., the distance from the outermost tip of corresponding paddles), may also be a half inch. There may be a line-to-line fit, such that when the compact carbonation device 300 is inserted into the tube, there is contact and friction between the tube and the device 300. Alternatively, the compact carbonation device 300 may be designed or used in connection with a tube that has an inner diameter that allows for a small gap to be positioned between the inner surface of the tube and the outermost point of the paddles.

In some examples, the paddles (and/or central member 302) may include a rough surface texture that is configured to increase turbulence in the flow of liquid. Alternatively, a smooth finish may be used.

The combination of the physical design of the compact carbonation device 300, as well as the chilled liquid that passes through, may enable the carbonation system to provide 3.5 vols of carbonation.

The pump 150 may be configured to circulate liquid through the liquid circulation loop 120. This circulation may occur when both the inlet valve 112 and the outlet valve 162 are closed, and the pump may slowly circulate the liquid through the loop 120. The pump may be associated with or may include a one-way valve 152, configured to enable the liquid to circulate only in one direction through the loop 120 (clockwise as shown in FIG. 1).

The controller 190 may control the pump 150 to circulate the liquid through the loop 120 when the inlet valve 112 and the outlet valve 162 are both closed, to enable the circulating liquid to pass through the TEC 130 multiple times to reduce its temperature, and to enable the reduced temperature liquid to pass through the reservoir 122 to re-freeze the melted PCM 172 (if there is any).

The outlet 160 enables liquid to exit the liquid circulation loop 120, via an outlet valve 162. There may be a single outlet 160 that enables both carbonated and uncarbonated liquid to exit the loop, through the same outlet valve 162. The outlet 160 may be positioned along the liquid circulation loop after the carbonation assembly 140.

The controller 190 may include electronics configured to receive data and signals from one or more sources (e.g., temperature sensors 180, 182, and 184). The controller 190 may also be connected to a user interface (not shown), through which a user may operate the beverage dispenser. Further, the controller 190 maybe connected to the inlet valve 112, the outlet valve 162, and the carbonation valve 142. Still further, the controller may be connected to the PCM assembly 170, which may include one or more sensors to measure a temperature of the PCM 172.

The controller 190 may control the operation of the various components of the beverage dispensing system 100. In some examples, the beverage dispenser may generally operate in three states, including an off state, and two on states. The two on states may include a first on state in which the beverage dispensing system 100 is dispensing liquid, and a second on state in which the beverage dispensing system 100 is in the process of circulating and cooling the liquid and the PCM.

In the first on state, the controller opens both the inlet valve 112 and the outlet valve (and optionally the carbonation valve 142), to chilled enable liquid to be dispensed and relatively warmer liquid to be input to the circulation loop 120. The newly input liquid may be circulated through the TEC, which reduces the temperature by some first amount. The liquid may then pass into the reservoir 122, which via contact with the PCM 172, will reduce in temperature again. In order to reduce the temperature of the liquid, the PCM 172 may partially melt. However, as a result, the dispensed liquid may be below the threshold desired temperature of the beverage dispenser. In this first on state, the output capacity of the beverage dispenser as a whole is increased, such that a continuous stream of liquid chilled to the desired temperature is available, and the continuous stream may be larger than a capacity of the beverage dispenser itself. The beverage dispensing system 100 may thus operate to dynamically chill an amount of liquid from the inlet to the outlet in a single pass, and in exchange melt the PCM 172. When the PCM 172 is fully melted, or is unable to extract further heat from the liquid in the reservoir, the beverage dispensing system 100 must stop in order to recover and/or re-freeze the PCM 172.

In the second on state, the beverage dispenser may be in a recovery mode, in which liquid is circulated through the liquid circulation loop 120 in order to chill the liquid and/or re-freeze any PCM 172 which has melted. The pump 150 is activated to relatively slowly pump the liquid through the circulation loop, and the TEC 130 acts to reduce the temperature of the liquid in the loop 120. The TEC 130 may be configured to reduce the temperature of the liquid to a predetermined amount that is above the liquid freezing temperature (e.g., 32 degrees Fahrenheit for water), and is also below the freezing point of the PCM (e.g., 36 degrees Fahrenheit). When the liquid in the liquid circulation loop 120 is chilled to below the freezing temperature of the PCM 172, the liquid may extract heat from the PCM 172, thereby re-freezing the PCM 172 and “recovering” the ability of the PCM 172 to chill any liquid that enters the reservoir 122 above the freezing point of the PCM 172. Once the PCM 172 has been re-frozen, the pump 150 and TEC 130 may be intermittently turned on and off to maintain a desired liquid temperature in the liquid circulation loop.

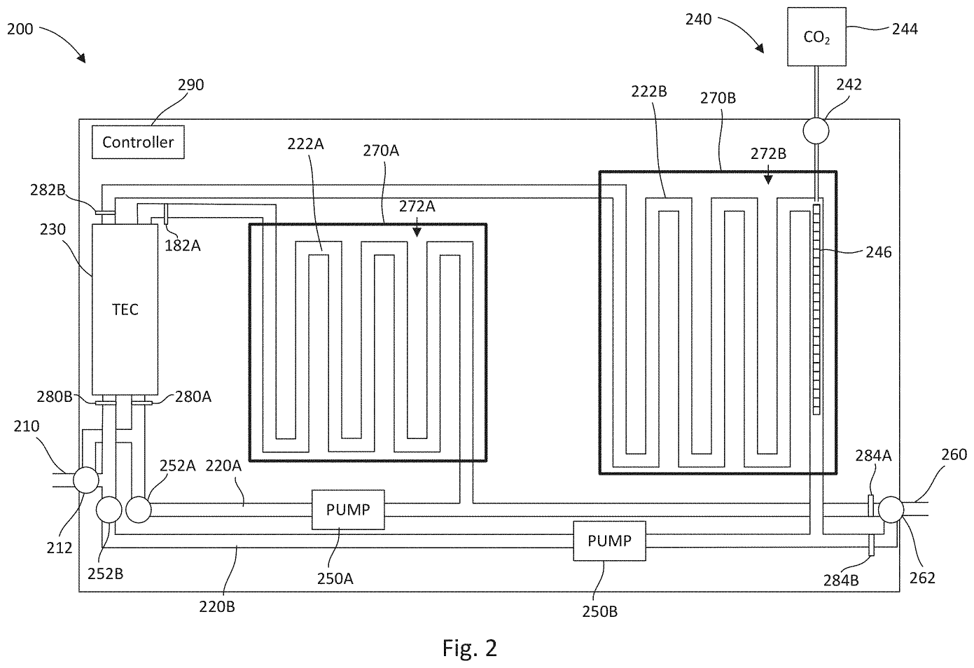

FIG. 2 illustrates a second example beverage dispensing system 200, which includes a separate liquid circulation loop for uncarbonated liquid (e.g., loop 220A) and carbonated liquid (e.g., loop 220B). The features and components of beverage dispensing system 200 may be similar or identical to the features and components of beverage dispensing system 100 described above with respect to FIG. 1

The first liquid circulation loop 220A and the second liquid circulation loop may share an inlet 210, and an outlet 260. The inlet 210 may include an inlet valve 212, configured to provide liquid to either or both of the first liquid circulation loop 220A, and the second liquid circulation loop 220B. The inlet valve 212 may be configured such that only one of the first loop 220A and the second loop 220B can receive liquid at a time. Alternatively, the inlet valve 212 may be configured such that both the first loop 220A and the second loop 220B receive liquid from the inlet 210.

The first liquid circulation loop 220A may be used to provide the outlet with chilled liquid without carbonation. The first loop 220A may include passing the input liquid from the inlet valve 212 into the TEC 230, and then into the first reservoir 222A. The first reservoir 222A may be surrounded in whole or in part by the first PCM assembly 270A, which includes a first PCM 272A. The first PCM 272A acts to extract heat from the liquid in the first reservoir 222A. The first reservoir 222A, first PCM assembly 270A, and first PCM 272A may be similar or identical to the corresponding parts noted above with respect to FIG. 1. The first liquid circulation loop 220A may also include a first pump 250A, which may be coupled with a first one-way valve 252A, which enables the liquid in the first circulation loop 220A to circulate in one direction (clockwise in FIG. 2). The first PCM 272A may have a freezing temperature that is greater than a freezing temperature of the liquid in the first liquid circulation loop 220A. The first PCM 272A may be configured to absorb heat from the liquid in the first reservoir 222A when a temperature of the liquid in the first reservoir 222A is greater than a temperature of the first PCM 272A, and release heat into the liquid in the first reservoir 222A when the temperature of the liquid in the first reservoir 222A is less than the temperature of the first PCM 272A.

The second liquid circulation loop 220B may be used to provide the outlet with chilled liquid that has carbonation. The carbonation assembly 240 includes a carbonation valve 242, a carbonation source 244, and a compact carbonation device 246. These components may be similar or identical to the components of the carbonation assembly 140 described above. The second loop 220B may include passing the input liquid from the inlet valve 212 into the TEC 230, and then into the second reservoir 222B. The second reservoir 222B may be surrounded in whole or in part by the second PCM assembly 270A, which includes a second PCM 272B. The second PCM 272B acts to extract heat from the liquid in the second reservoir 222B. The second reservoir 222B, second PCM assembly 270B, and second PCM 272B may be similar or identical to the corresponding parts noted above with respect to FIG. 1. The second liquid circulation loop 220B may also include a second pump 250B, which may be coupled with a second one-way valve 252B, which enables the liquid in the second liquid circulation loop 220B to circulate in one direction (clockwise in FIG. 2). The second PCM 272B may have a freezing temperature that is greater than a freezing temperature of the liquid in the second liquid circulation loop 220B. The second PCM 272B may be configured to absorb heat from the liquid in the second reservoir 222B when a temperature of the liquid in the second reservoir 222B is greater than a temperature of the second PCM 272B, and release heat into the liquid in the second reservoir 222B when the temperature of the liquid in the second reservoir 222B is less than the temperature of the second PCM 272B.

In some examples, the PCM used for PCM 272A and PCM 272B may be the same, such that they have the same freezing point and melting point. Alternatively, a different PCM may be used for each, such that the freezing/melting temperature of PCM 272A is different from a freezing/melting temperature of PCM 272B. This may be done based on the different in freezing point between the carbonated and uncarbonated liquids in the first and second circulation loops. Different PCMs may also be used where different temperature outputs are desired for carbonated vs. uncarbonated liquid.

The outlet 260 may enable liquid to be dispensed to a user. Similar to the operation of the first beverage dispensing system 100, the second beverage dispensing system may use the input pressure from the liquid at the inlet 210 to cause liquid in either the first liquid circulation loop 220A or the second liquid circulation loop 220B to be dispensed. To accomplish this, the outlet valve 262 may be similar to the inlet valve 212 in that the outlet valve 262 is configured to enable liquid from either the first liquid circulation loop 220A or the second liquid circulation loop 220B to be output from the system 200. In this way, both the first loop 220A and the second loop 220B may share the same outlet 210 and/or outlet valve 212, enabling a the system 200 to have a single outlet.

The second liquid circulation loop 220B may also include the carbonation assembly 240, which includes a carbonation valve 242, a carbonation source 244, and a compact carbonation device 246. These components may be similar or identical to the carbonation assembly 140 described above with respect to FIG. 1.

The second beverage dispensing system 200 may include a shared TEC 230, which may reduce the temperature of liquid in both the first loop 220A and the second loop 220B. This is shown in FIG. 2. Alternatively, the system 200 may include two or more TECs, such that each loop 220A and 220B includes a separately controllably TEC.

The controller 290 may be configured to control the various components and valves of the system 200, based on information received from one or more temperature sensors 280A, 280B, 282A, 282B, 284A, and 284B. Additional temperature sensors may also be used. Furthermore, the controller 290 may be coupled with a user interface, to enable a user to interact with and control the operation of the beverage dispensing system 200.

In some examples, the placement of the various components of the system 200 along the first liquid circulation loop 220A and the second liquid circulation loop 220B may be important for the operation of the system. As illustrated n FIG. 2, the components may be positioned such that liquid in the first liquid circulation loop 220A is configured to pass first from the inlet 210 through the TEC 230, from the TEC 230 through the first reservoir 222A, and from the first reservoir 222A to the outlet 260. Liquid from the second liquid circulation loop 220B is configured to pass first from the inlet 210 through the TEC 230, from the TEC 230 through the second reservoir 222B, from the second reservoir 222B through the carbonation assembly 240 (or as shown in FIG. 2, wherein the compact carbonation device 246 comprises an end of the reservoir 222B), and from the carbonation assembly 240 to the outlet 260.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure.

What is claimed is:

1. A beverage dispensing system comprising:
a liquid circulation loop, the liquid circulation loop including a reservoir;
an inlet coupled to the liquid circulation loop to enable liquid to enter the liquid circulation loop;
a thermoelectric cooling assembly configured to lower a temperature of liquid in the liquid circulation loop;
a carbonation assembly configured to add carbonation to the liquid in the liquid circulation loop;
a pump configured to circulate liquid through the liquid circulation loop; and
an outlet coupled to the liquid circulation loop to enable liquid to exit the liquid circulation loop.

2. The beverage dispensing system of claim 1, further comprising an inlet valve coupled to the inlet, and an outlet valve coupled to the outlet, wherein the carbonation assembly further comprises a carbonation valve, and wherein the outlet valve is configured to output either carbonated water or uncarbonated water based on whether the carbonation valve is open or closed.

3. The beverage dispensing system of claim 1, further comprising a phase change material assembly positioned to at least partially surround the reservoir.

4. The beverage dispensing system of claim 3, wherein the phase change material assembly comprises a phase change material having a freezing temperature that is greater than a freezing temperature of the liquid in the liquid circulation loop, and wherein the phase change material is configured to:
absorb heat from liquid in the reservoir when a temperature of the liquid in the reservoir is greater than a temperature of the phase change material; and
release heat into the liquid in the reservoir when the temperature of the liquid in the reservoir is less than the temperature of the phase change material.

5. The beverage dispensing system of claim 1, wherein the carbonation assembly is an in-line carbonation assembly, configured to carbonate liquid within the liquid circulation loop.

6. The beverage dispensing system of claim 1, wherein the carbonation assembly comprises a carbonation valve configured to be open or closed, and wherein liquid in the liquid circulation loop passes through the carbonation assembly both when the carbonation valve is open and when the carbonation valve is closed.

7. The beverage dispensing system of claim 1, wherein the thermoelectric cooling assembly is configured to provide a variable amount of cooling, and wherein the variable amount of cooling is determined based on a signal from one or more temperature sensors positioned to measure a temperature of liquid in the liquid circulation loop.

8. The beverage dispensing system of claim 1, wherein liquid in the liquid circulation loop is configured to pass first from the inlet through the thermoelectric cooling assembly, from the thermoelectric cooling assembly through the reservoir, from the reservoir through the carbonation assembly, and from the carbonation assembly to the outlet.

9. A beverage dispensing system comprising:
an inlet;
a first liquid circulation loop including a first reservoir;
a first pump configured to circulate liquid through the first liquid circulation loop;
a second liquid circulation loop including a second reservoir;
a carbonation assembly configured to add carbonation to the liquid in the second liquid circulation loop;
a second pump configured to circulate liquid through the second liquid circulation loop;
a thermoelectric cooler configured to lower a temperature of liquid circulating in both the first liquid circulation loop and the second liquid circulation loop; and
an outlet coupled to the first liquid circulation loop and the second liquid circulation loop.

10. The beverage dispensing system of claim 9, further comprising:
a first inlet valve coupled to the inlet, configured to control whether liquid enters the first liquid circulation loop;
a second inlet valve coupled to the inlet, configured to control whether liquid enters the second circulation loop;
a first outlet valve coupled to the outlet, configured to control whether liquid exits the first circulation loop; and
a second outlet valve coupled to the outlet, configured to control whether liquid exits the second circulation loop,
wherein the carbonation assembly further comprises a carbonation valve, configured to control whether carbonation is added to liquid in the second liquid circulation loop.

11. The beverage dispensing system of claim 9, further comprising:
a first phase change material assembly positioned to at least partially surround the first reservoir; and
a second phase change material assembly positioned to at least partially surround the second reservoir.

12. The beverage dispensing system of claim 11, wherein:
the first phase change material assembly includes a first phase change material having a freezing temperature that is greater than a freezing temperature of the liquid in the first liquid circulation loop, and wherein the first phase change material is configured to:
absorb heat from liquid in the first reservoir when a temperature of the liquid in the first reservoir is greater than a temperature of the first phase change material; and
release heat into the liquid in the first reservoir when the temperature of the liquid in the first reservoir is less than the temperature of the first phase change material, and
the second phase change material assembly includes a second phase change material having a freezing temperature that is greater than a freezing temperature of the liquid in the second liquid circulation loop, and wherein the second phase change material is configured to:
absorb heat from liquid in the second reservoir when a temperature of the liquid in the second reservoir is greater than a temperature of the second phase change material; and
release heat into the liquid in the second reservoir when the temperature of the liquid in the second reservoir is less than the temperature of the second phase change material.

13. The beverage dispensing system of claim 9, wherein the carbonation assembly is an in-line carbonation assembly, configured to carbonate liquid within the second liquid circulation loop.

14. The beverage dispensing system of claim 9, wherein the carbonation assembly comprises a carbonation valve configured to be open or closed, and wherein liquid in the second liquid circulation loop passes through the carbonation assembly both when the carbonation valve is open and when the carbonation valve is closed.

15. The beverage dispensing system of claim 9, wherein the thermoelectric cooling assembly is configured to provide a variable amount of cooling, and wherein the variable amount of cooling is determined based on a signal from one or more temperature sensors positioned to measure a first temperature of liquid in the first liquid circulation loop, and a second temperature of liquid in the second liquid circulation loop.

16. The beverage dispensing system of claim 9, wherein:
liquid in the first liquid circulation loop is configured to pass first from the inlet through the thermoelectric cooling assembly, from the thermoelectric cooling assembly through the first reservoir, and from the first reservoir to the outlet, and
liquid from the second liquid circulation loop is configured to pass first from the inlet through the thermoelectric cooling assembly, from the thermoelectric cooling assembly through the second reservoir, from the second reservoir through the carbonation assembly, and from the carbonation assembly to the outlet.

17. A compact carbonation system for a beverage dispenser, the compact carbonation system comprising:
a tube; and
a compact carbonation device positioned inside the tube, the compact carbonation device comprising:
a central member extending along a longitudinal axis; and
a plurality of pairs of paddles attached to the central member and positioned adjacent to each other along the longitudinal axis,
wherein a first pair of the plurality of pairs of paddles extends in a first helical direction with respect to the longitudinal axis, and a second pair of the plurality of pairs of paddles adjacent to the first pair extends in an opposing helical direction, such that a rotational component of the second pair is opposite to a rotational component of the first pair.

18. The compact carbonation system of claim 17, wherein the compact tube has a first inner diameter, and wherein the compact carbonation device has an diameter that matches the first inner diameter such that there is a line-to-line fit.

19. The compact carbonation system of claim 17, wherein each paddle of the plurality of pairs of paddles extends 180 degrees along a rotational axis of the central member, and wherein each pair of paddles of the plurality of pairs of paddles includes opposing paddles that extend in a double helix pattern.

20. The compact carbonation system of claim 17, wherein each paddle of the plurality of pairs of paddles has a pitch of between 40-50 degrees.
